(19) United States
(12) Patent Application Publication
(10) Pub. No.: US 2014/0307811 A1
(43) Pub. Date: Oct. 16, 2014

(54) SERIALLY CONNECTED POWER LINE COMMUNICATION APPARATUS AND POWER LINE COMMUNICATION METHOD THEREOF

(71) Applicant: Electronics and Telecommunications Research Institute, Daejeon (KR)

(72) Inventors: Jinsoo HAN, Daejeon (KR); Chang-Sic CHOI, Daejeon (KR); Wan-Ki PARK, Daejeon (KR); Ilwoo LEE, Daejeon (KR)

(73) Assignee: Electronics and Telecommunications Research Institute, Daejeon (KR)

(21) Appl. No.: 14/208,115

(22) Filed: Mar. 13, 2014

(30) Foreign Application Priority Data
Apr. 15, 2013 (KR) 10-2013-0041244

(51) Int. Cl. H04B 3/56

(52) U.S. Cl. CPC H04B 3/56
USPC 375/257

(57) ABSTRACT

Power line communication apparatuses, which are serially connected with power line. The power line communication apparatus may include a bypass unit to be serially connected to power line, and pass a communication signal that flows along the power line; a coupling circuit to be connected to two ends of the bypass unit, and couple the communication signal to the power line; an analog front end (AFE) unit to transform an input/output analog signal so that the input/output analog signal is transferred to the power line, and transfer the input/output analog signal to the coupling circuit unit; and a controller to transfer the communication signal, which is to be transferred through the power line to the AFE unit.

### CROSS-REFERENCE TO RELATED APPLICATION(S)

This application claims the benefit under 35 U.S.C. §119(a) of Korean Patent Application No. 10-2013-0041244, filed on Apr. 15, 2013, in the Korean Intellectual Property Office, the entire disclosure of which is incorporated herein by reference for all purposes.

### BACKGROUND

1. Field

The following description relates to a power line communication apparatus and method for monitoring each module of strings connecting two or more solar modules in series, in a solar generation system that connects two or more solar modules to generate electric power.

2. Description of the Related Art

Recently, a communication method using already built power line is being developed. A power line communication is a technology using a pre-existing power line without using an Unshielded Twisted Pair (UTP) cable or a telephone line. If the power line is connected to sockets of home or office, the communication technology connects all home information devices, such as a television, a telephone, and a computer, etc., through next generation high-speed information communication subscriber network service, which can enable a user to use a voice, data, and internet, etc., at a high speed.

Using the power line communication method decreases a data transmission path into one power line, wherein until now the data transmission path has been made complex with wired television networks, telephone lines, and optical networks, etc. Thus, it is possible to easily communicate data in a simple structure in complex wirings. Also, because only additional devices are needed, such as a modem or a system that distributes power, and communication data to the pre-existing power line, there is no need to install new paths, so the path cost can be reduced. In addition, it is possible to not only construct an internet service and a network, but also remotely control power line-based intelligent home appliances, remotely read meters, etc., and remotely control various electronic devices, and the like. When using such power line communication technology in a general alternating current (AC) power supply, a structure is formed, which is connected in parallel to the power lines as a bus form. Such a structure is used in a network construction, and the like, using indoor power line communications. A method for connecting a power line modem to each plug socket to access the indoor network is widely used. At this time, at least 2 electric wires are connected to each power line modem, thus power line communication signals can be transmitted and received. In such parallel connection, a physical connection structure is the same even in a direct current (DC) power.

On the other hand, a solar power generation system converts DC, which is generated from a solar battery module by using sunlight, to AC in an inverter. Also, the solar power generation system boosts the voltage (330V˜22.9kV) in an AC distributing board, and reversely transmits the entire quantity to electrical power systems through Korea Electric Power Corporation (KEPCO). However, lately, due to surges in supply of the solar power generation system, the need to remotely read and monitor the operational states of the entire solar power generation system is increasing accordingly.

Generally, however, in the solar power generation system, a plurality of solar modules are connected through one string, and each solar module is connected in series to gain high voltage. Only one electric wire is connected between each solar module.

Communication signals must be transferred through one wired line; however, the general solar module includes a plurality of cells composed of current sources and diodes, and additional diodes to prevent a short caused by abnormal operations of specific cells. Thus, such solar module structure does not facilitate transmission of power line communication signals.

### SUMMARY

The following description relates to a power line communication apparatus and method thereof for transferring a communication signal more effectively, in a solar generation system formed in a serially connected structure.

In one general aspect, a power line communication apparatus may include a bypass unit to be serially connected to power line, and pass a communication signal that flows along power line; a coupling circuit unit configured to be connected to two ends of the bypass unit, and couple the communication signal to the power line; an analog front end (AFE) unit configured to transform an input/output analog signal so that the input/output analog signal is transferred to the power line, and transfer the input/output analog signal to the coupling circuit unit; and a controller configured to transfer the communication signal, which is to be transferred through the power line, to the AFE unit.

Other features and aspects may be apparent from the following detailed description, the drawings, and the claims.

### BRIEF DESCRIPTION OF THE DRAWINGS

FIG. 1 is a diagram illustrating an example of a composition of a power line communication apparatus in a solar generation system according to an exemplary embodiment.

FIGS. 2A and 2B are diagrams illustrating an example of an internal composition of a power line communication apparatus connected to a solar module according to an exemplary embodiment.

FIG. 3 is a flowchart illustrating an example of a power line communication method connected to a solar module according to an exemplary embodiment.

FIGS. 4A and 4B are diagrams illustrating examples of an internal composition of a power line communication apparatus connected to a solar module according to an exemplary embodiment.

FIG. 5 is a flowchart illustrating an example describing a power line communication method connected to a solar module according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

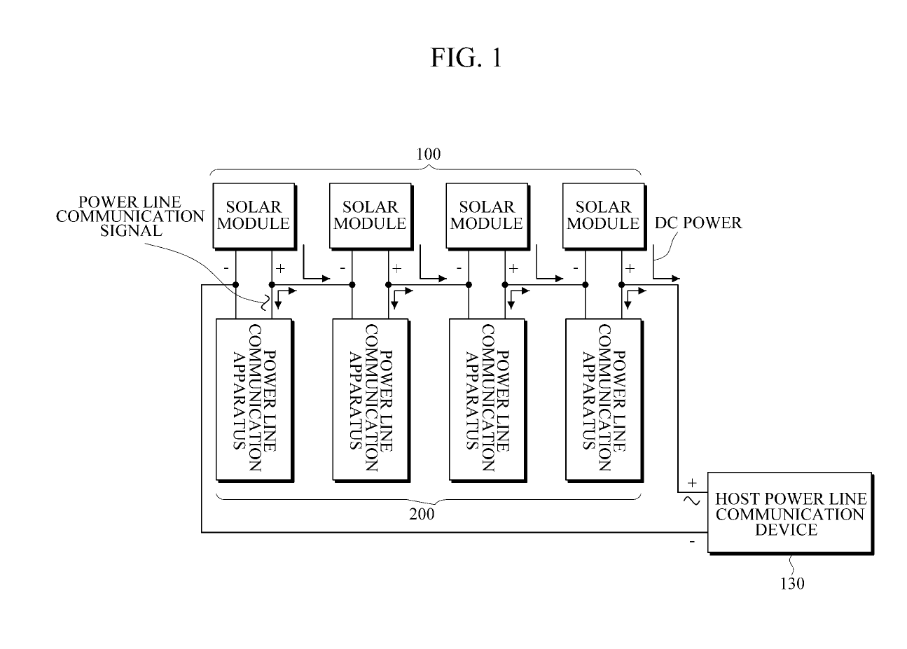

FIG. 1 is a diagram illustrating an example of a composition of a power line communication apparatus in a solar generation system according to an exemplary embodiment.

Referring to FIG. 1, the solar generation system includes two or more solar modules 100 serially connected to each other. That is, a positive pole of each of the solar modules 100 is connected to a negative pole of another solar module.

In addition, two or more power line communication apparatuses 200 are connected to two poles of each solar module 100, and may gain direct current power from the solar modules 100. The solar generation system is a structure, where each of the power line communication apparatus 200 is serially connected to each other, and ultimately gains direct current power of high voltage in a host power line communication apparatus 130.

Communication signals should be transferred through one power line; however, a general solar module is composed of a plurality of cells that include current source and diodes, and additional diodes to avoid a short circuit caused by unusual operations of a certain cell. Such solar module structure does not facilitate the transmission of the power line communication signals.

According to exemplary embodiments of the serially connected power line communication apparatus and method thereof, to overcome the problems caused by the structure of those solar modules, and to make communication easy between the power line communication apparatuses, the communication signals, which the power line communication apparatus generates as illustrated in FIG. 1, should pass through the neighboring serially connected solar modules in order, be transferred to each power line communication apparatus 200 connected to each solar module 100, and finally arrive at a host power line communication apparatus 130. To that end, the exemplary embodiments of the power line communication apparatus 200 may include a bypass unit that transmits the communication signals.

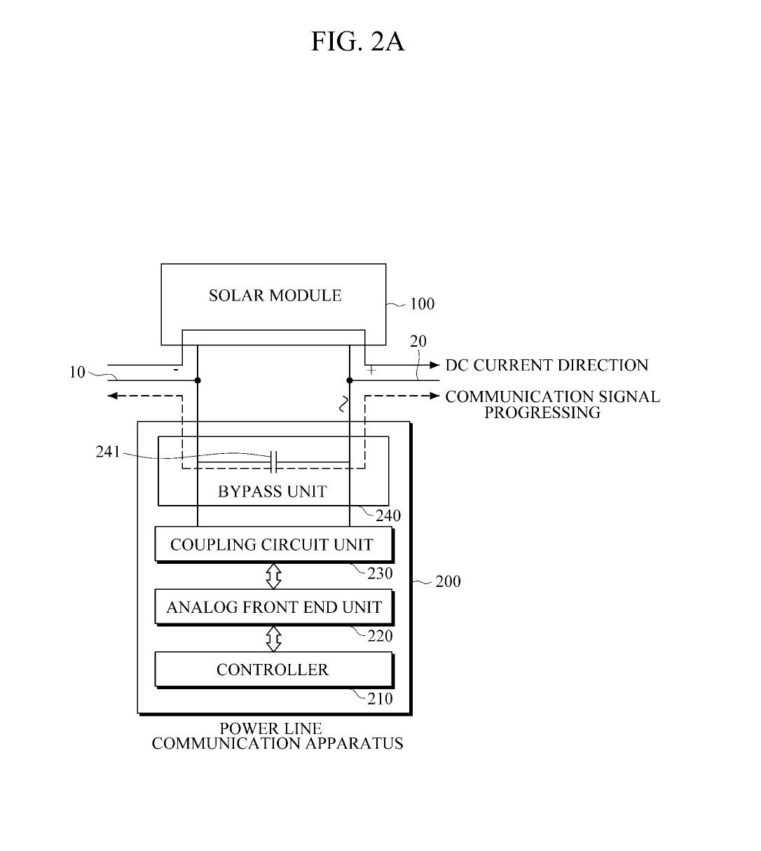

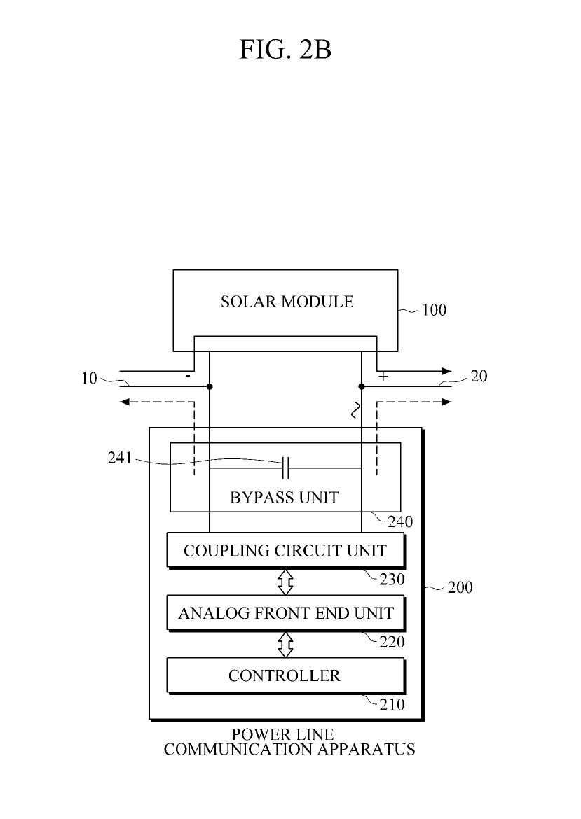

FIGS. 2A and 2B are diagrams illustrating an example of a detailed composition of a power line communication apparatus according to an exemplary embodiment. Here, FIG. 2A illustrates communication signals, which are bypassed and transferred to another neighboring power line communication apparatus, wherein the communication signals are generated via the power line communication apparatus. Also, FIG. 2B illustrates communication signals, which are coupled to power line communication tracks and transferred to another neighboring power line communication apparatus, wherein the communication signals are generated in the power line communication apparatus.

Referring FIGS. 2A and 2B, the power line communication apparatus 200 includes a controller 210, an analog front end (AFE) unit 220, a coupling circuit unit 230, and a bypass unit.

The controller 210 is composed of a transceiver that includes a physical layer to execute the power line communication with a Central Processing Unit (CPU) that executes data processing and calculation, etc., and a Media Access Control (MAC) layer not illustrated in FIGS. 2A and 2B. The transceiver is in charge of receiving and transferring the communication signals.

In addition, the controller 210 may be equipped with an interface for additional serial communication, Ethernet communication, or Wireless Personal Area Network (WPAN) communication to communicate with other devices, as well as the power line communication. Also, the controller 210 may be equipped with an additional interface to collect sensing information from external sensor devices. Here, for example, the interface to collect the sensing information may be an interface that can be connected to a device, such as a temperature sensor. Thus, the controller 210 may transmit data, which is received through the power line communication, to an external device through the additional interface, or transfer data, which is received from the external device, through the power line communication.

The analog front end (AFE) unit 220 converts input/output (I/O) analog signals of the controller 210 appropriately for power line 10 and 20 through a filter and an amplifier (not illustrated), etc., and transfers the I/O analog signals. In other words, the AFE unit 220 allows the analog signals, which are transferred from the controller 210 for the power line communication, to be transferred to the power line 10 and 20, and transfer the analog signals to the controller 210.

The coupling circuit unit 230 enables the communication signals to be coupled between the power line 10 and 20 through the AFE unit 220. The coupling circuit unit 230 applies output signals from the AFE unit 220 to the power line 10 and 20, and transferring the signals, transferred from the power line 10 and 20, to the AFE unit 220, as illustrated in FIG. 2B.

The bypass unit 240 is serially connected to the power line 10 and 20, and passes the communication signals that flow along the power line 10 and 20, as illustrated in FIG. 2A. In addition, the communication signals that pass through the bypass unit 240 may be transferred to the controller 210 after going through the coupling circuit unit 230 by a control of the controller 210. The bypass unit 240 includes electrical elements that pass alternating current signals, such as a capacitor 241. Thus, direct current (DC) flows through the solar module 100, but because the capacitor 241 does not allow the direct current to pass, only the communication signals, which are the alternating current (AC), are passed through the bypass unit 240.

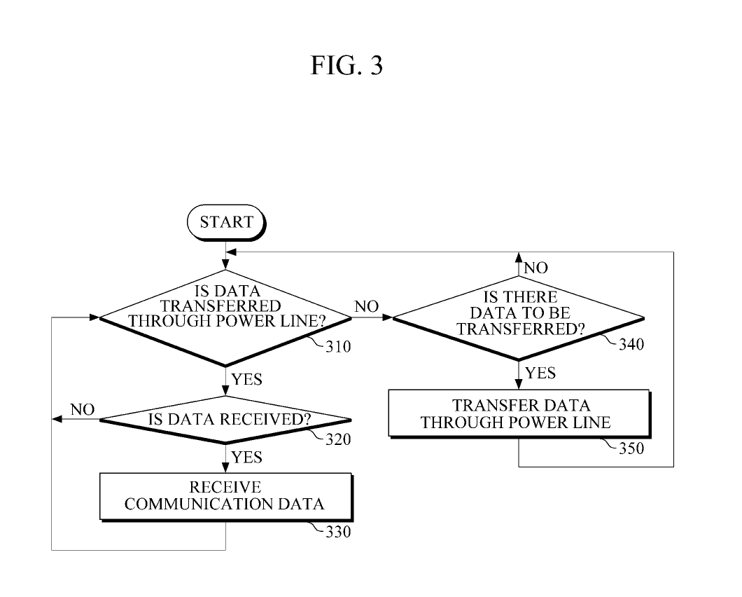

FIG. 3 is a flowchart illustrating an example describing a serially connected power line communication method according to an exemplary embodiment.

Referring to FIG. 3, a controller 210 determines whether data is transferred through power line 10 and 20 in 310. If the determination result of the operation 310 shows a case where the data is being transferred through the power line 10 and 20, the controller 210 determines whether to receive communication signal data transmitted through the power line 10 and 20 in 320. In other words, the controller 210 determines whether to only bypass the communication signal data transmitted through the power line 10 and 20, or receive the communication signal data as well as bypassing.

If the determination result of the operation 320 shows a case in which the communication signal data transmitted through the power line 10 and 20 is to be received, the controller 210 receives the communication signal data, which is transmitted through the power line, through a coupling circuit unit 230 in 330. Though not illustrated in FIGS. 2A and 2B, however, the received communication signal data may be transmitted to another communication apparatus.

In an exemplary embodiment, if the determination result of the operation 310 shows a case where the data is not being transferred through the power line 10 and 20, the controller 210 determines whether there is data to be transferred in 340.

If the determination result of the operation 340 shows a case where there is the data to be transferred through the power line, the controller 210 enables the coupling circuit unit 230 to control transferring the data through the power line 10 and 20 in 350.

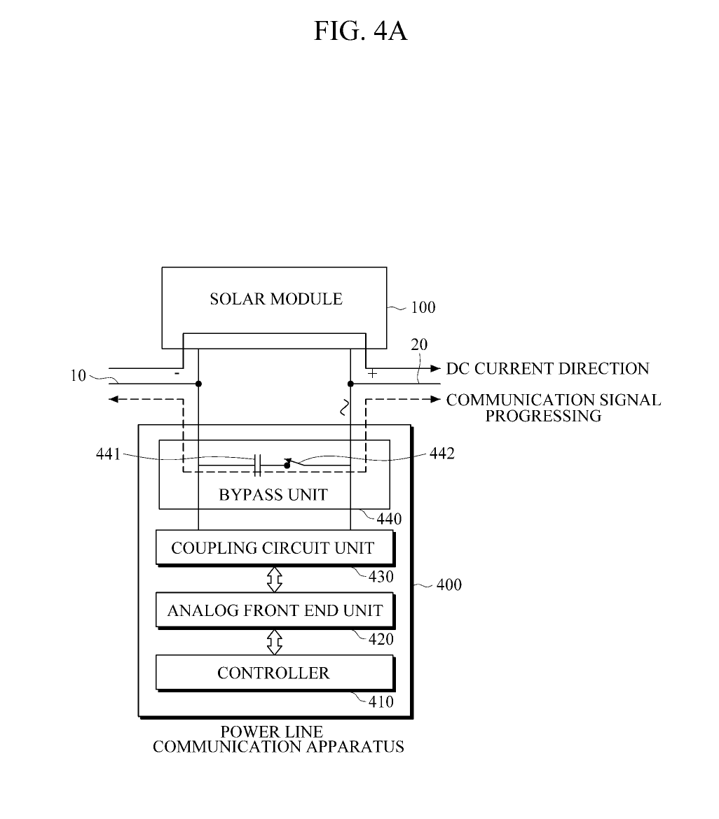

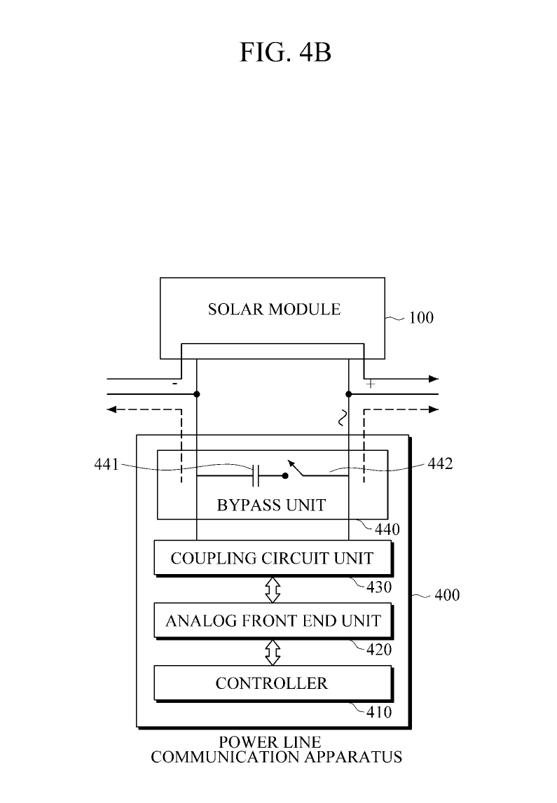

FIGS. 4A and 4B are detailed diagrams illustrating an example of a power line communication apparatus according to an exemplary embodiment. Here, FIG. 4A illustrates communication signals are bypassed and transferred to another neighboring power line communication apparatus, wherein the communication signals are generated via a neighboring power line communication apparatus. Also, FIG. 4B illustrates communication signals, which are coupled to power line communication and transferred to another neighboring power line communication apparatus, wherein the communication signals are generated in the power line communication apparatus.

Compared to FIGS. 2A and 2B, a bypass unit 440 of a power line communication apparatus 200, which is illustrated in FIGS. 4A and 4B, includes electrical elements, such as a capacitor 441, and the like, which pass alternating current signals, and a relay added to the capacitor 441 serially.

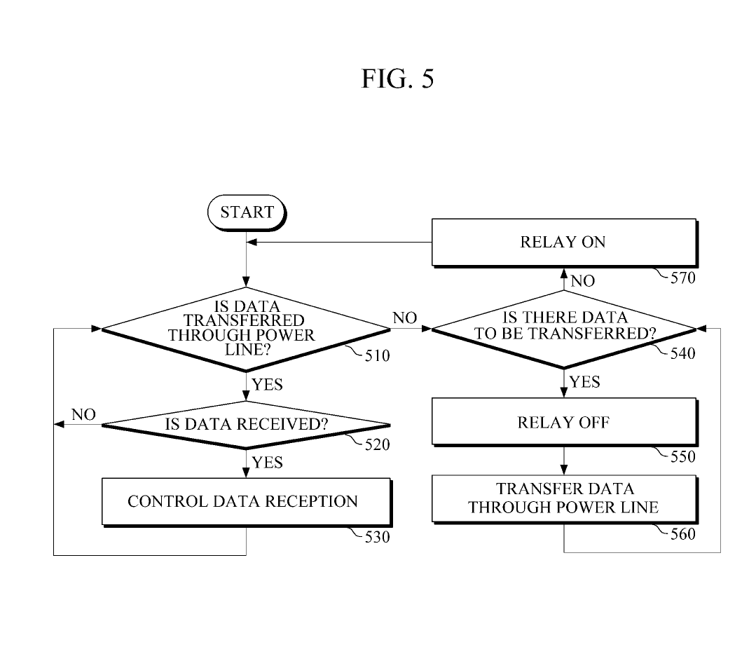

In a state where the relay is closed as illustrated in FIG. 4A, the controller 410 passes the communication signals through the capacitor 441. In addition, in a state where the relay is open as illustrated in FIG. 5, the communication signals cannot be transferred through the capacitor 441.

Openness and closedness of such relay of the bypass unit 440 are controlled by the controller 410. When the controller 410 tries to transmit the power line communication signals, the communication signals applied through the coupling circuit unit 430 may be partly absorbed or lost at two ends of the capacitor 441 of the bypass unit 440. So, by enabling the relay to be open when the controller 410 applies the power line communication signals, the loss of the communication signals by the capacitor 441 may be avoided, which is a strength. Also, because Carrier Sense Multiple Access with Collision Detection (CSMA-CD) or Carrier Sense Multiple Access with Collision Avoidance (CSMA-CA) methods are used in communicating using shared media, each device stands by without applying the signals if there are communication signals already in the shared media. Thus, because it is in a state where no signals in the shared media exist when the power line communication apparatus 400 applies the communication signals, even if the relay is open, preventing the communication signals from being passed through the capacitor does not cause any communication problems. That is, only when the controller 410 applies the signals in connection with CSMA-CD/CA, the controller 410 opens the relay without interrupting the communication.

FIG. 5 is a flowchart illustrating an example describing a serially connected power line communication method according to an exemplary embodiment.

Referring to FIG. 5, a controller 410 determines whether data is being transferred through power line 10 and 20 in 510. At this time, a relay of a bypass unit 440 is on. As the determination result of the operation 510, in a case where the data is being transferred through the power line 10 and 20, the controller 410 determines whether to receive the communication signal data transmitted through the power line 10 and 20 in 520. In other words, the controller 410 determines whether to only bypass the communication signal data transmitted through the power line 10 and 20, or receive the communication signal data as well as bypassing.

If the determination result of the operation 520 shows a case of receiving the communication signal data transmitted through the power line 10 and 20, the controller 410 receives communication signal data, which is transmitted through the power line 10 and 20, through a coupling circuit unit 430 in 530. Not illustrated in FIGS. 4A and 4B, however, the received communication signal data may be transmitted to another communication apparatus.

In an exemplary embodiment, if the determination result of the operation 510 shows a case where the data is not being transferred through the power line 10 and 20, the controller 410 determines whether there is the data to be transferred in 540.

If the determination result of the operation 540 shows a case where there is the data to be transferred, the controller 410 turns the relay off, and enables the coupling circuit unit 430 to control transferring the data through the power line 10 and 20. According to the composition of the invention according to the exemplary embodiments, when a plurality of the solar modules are connected to each other serially, and the power line communication is used to monitor the states, such as voltage/current of each solar module, and the like, the power line communications can be more effectively performed between the power line communication apparatuses, each of which is attached to each solar module, in where the power lines are connected serially.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A power line communication apparatus, comprising:
a bypass unit configured to be serially connected to power line, and pass a communication signal that flows along the power line;
a coupling circuit unit configured to be connected to two ends of the bypass unit, and couple the communication signal to the power line;
an analog front end (AFE) unit configured to transform an input/output analog signal so that the input/output analog signal is transferred to the power line, and transfer the input/output analog signal to the coupling circuit unit; and
a controller configured to transfer the communication signal, which is to be transferred through the power line, to the AFE unit.

2. The power line communication apparatus of claim 1, wherein the bypass unit includes a capacitor.

3. The power line communication apparatus of claim 1, wherein the bypass unit includes a relay connected to the capacitor in series.

4. The power line communication apparatus of claim 3, wherein the controller turns the relay on in response to receiving the communication signal transmitted through the power line, and turns the relay off in response to applying the communication signal to the power line.

5. The power line communication apparatus of claim 1, wherein the controller is configured to:
comprise an interface that executes at least one of serial communication, Ethernet communication, and a Wireless Personal Area Network (WPAN) communication; and
transmit the communication signal, which is received through the power line, to an external device through the interface, or apply the data received from the external device to the power line as the communication signal through the interface.

6. A power line communication method for communication between serially connected power line communication apparatuses, the power line communication method comprising:
determining whether data is being transferred through power line; and
in response to a determination that data is being transferred through the power line, receiving communication signal data transmitted through the power line.

7. The power line communication method of claim 6, further comprising:
in response to a determination that the data is not being transferred through the power line, determining whether there is data to be transferred to the power line; and
in response to the determination that there is the data to be transferred to the power line, transferring the data to the power line.

8. The power line communication apparatus of claim 7, further comprising, in response to the determination that there is the data to be transferred to the power line:
turning off a relay serially connected to a capacitor that bypasses the communication signal of the power line; and
transferring the data to be transferred to two ends of the power line.

9. The power line communication apparatus of claim 7, further comprising:
in response to the determination that there is no data to be transferred to the power line, turning on a relay serially connected to a capacitor that bypasses the communication signal of the power line.
